(19) United States
(12) Patent Application Publication
(10) Pub. No.: US 2025/0217798 A1
(43) Pub. Date: Jul. 3, 2025

(54) ENHANCED AND EFFICIENT DATA FLOW

(71) Applicant: Visa International Service Association, San Francisco, CA (US)

(72) Inventor: Jarkko Sevanto, Berkeley, CA (US)

(73) Assignee: Visa International Service Association, San Francisco, CA (US)

(21) Appl. No.: 18/986,426

(22) Filed: Dec. 18, 2024

Related U.S. Application Data
(60) Provisional application No. 63/615,099, filed on Dec. 27, 2023.

(51) Int. Cl. G06Q 20/38; G06Q 20/40; H04L 67/55

(52) U.S. Cl. CPC G06Q 20/385; G06Q 20/401; H04L 67/55

(57) ABSTRACT

A method is disclosed. The method includes receiving, by a receiver entity computer from a network processing computer, a first push transfer message comprising a credential and a value. The method includes determining that the value exceeds a threshold, transmitting, to the network processing computer, a first response message comprising a record value associated with a record maintained by the receiver entity computer, and an indicator declining the first push transfer message. The method also includes receiving, from the network processing computer, a second push transfer message comprising the record value or another value less than the record value, and transmitting, to the network processing computer, a second response message comprising an approval indicator.

### CROSS-REFERENCE TO RELATED APPLICATIONS

This application is a non-provisional application of U.S. patent application No. 63/615,099, filed on Dec. 27, 2023, which is herein incorporated by reference in its entirety.

### BACKGROUND

Pull transactions can involve pulling a value from one record to another record. A pull transaction is processed as a dual-message transaction, meaning that authorization and clearing are two distinct events. In a partial authorization pull transaction, an authorizing entity computer partially authorizes a pull message associated the transaction. An originator such as a resource provider can accept the partial authorization and use the adjusted transaction amount in a clearing process. Alternatively, the originator can reject the partial authorization and reverse the original pull message entirely. In either case, this type of interaction involves the use of multiple messages between originator and the authorizing entity computer including the initial pull message, the rejection or reversal message, and a clearing message. There is a need to reduce the number of messages for transactions, as they can consume computing resources and time.

Embodiments of the invention address these and other problems, individually and collectively.

### BRIEF SUMMARY

One embodiment of the invention includes a method comprising: receiving, by a receiver entity computer from a network processing computer, a first push transfer message comprising a credential and a value; determining, by the receiver entity computer, that the value exceeds a threshold; transmitting, by the receiver entity computer to the network processing computer, a first response message comprising a record value associated with a record maintained by the receiver entity computer, and an indicator declining the first push transfer message; receiving, by the receiver entity computer from the network processing computer, a second push transfer message comprising the record value or another value less than the record value; and transmitting, by the receiver entity computer to the network processing computer, a second response message comprising an approval indicator.

Another embodiment of the invention includes a receiver entity computer comprising: a processor; and a non-transitory computer readable medium comprising code executable by the processor, for performing operations comprising receiving, from a network processing computer, a first push transfer message comprising a credential and a value, determining that the value exceeds a threshold, transmitting, to the network processing computer, a first response message comprising a record value associated with a record maintained by the receiver entity computer, and an indicator declining the first push transfer message, receiving, from the network processing computer, a second push transfer message comprising the record value or another value less than the record value, and transmitting, to the network processing computer, a second response message comprising an approval indicator.

Another embodiment of the invention includes a method comprising: receiving, by a network processing computer from a sender entity computer, a first push transfer message comprising a value; transmitting, by the network processing computer, the first push transfer message to a receiver entity computer, wherein the receiver entity computer determines that the value exceeds a threshold, and transmits, to the network processing computer, a first response message comprising a record value associated with a record maintained by the receiver entity computer, and an indicator declining the first push transfer message; receiving, by the network processing computer, the first response message; transmitting, by the network processing computer, the first response message to the sender entity computer; receiving, by the network processing computer, a second push transfer message comprising the record value or another value less than the record value; receiving, by the network processing computer, a second response message comprising an approval indicator; and transmitting, by the network processing computer, the second response message comprising the approval indicator to the sender entity computer.

Another embodiment of the invention includes a network processing computer comprising a processor, and a computer readable medium. The computer readable medium comprises code, executable by the processor, for performing a method comprising: receiving, by the network processing computer from a sender entity computer, a first push transfer message comprising a value; transmitting, by the network processing computer, the first push transfer message to a receiver entity computer, wherein the receiver entity computer determines that the value exceeds a threshold, and transmits, to the network processing computer, a first response message comprising a record value associated with a record maintained by the receiver entity computer, and an indicator declining the first push transfer message; receiving, by the network processing computer, the first response message; transmitting, by the network processing computer, the first response message to the sender entity computer; receiving, by the network processing computer, a second push transfer message comprising the record value or another value less than the record value; receiving, by the network processing computer, a second response message comprising an approval indicator; and transmitting, by the network processing computer, the second response message comprising the approval indicator to the sender entity computer.

These and other embodiments are described in further detail below.

### BRIEF DESCRIPTION OF THE DRAWINGS

FIG. 1 shows a block diagram of a system and an overlaid flow diagram illustrating an embodiment of the invention.

FIG. 2 shows a block diagram of a user device according to an embodiment.

FIG. 3 shows a block diagram of a network processing computer according to an embodiment.

FIG. 4 shows a block diagram of a receiver entity computer according to an embodiment.

### DETAILED DESCRIPTION

Prior to discussing specific embodiments of the invention, some terms may be described in detail.

“Account information” may include any suitable information associated with an account (e.g., a personal account number and/or payment device associated with the account). Such information may be directly related to the account or may be derived from information related to the account. Examples of account information may include a PAN (primary account number or “account number”), username, expiration date, and verification values such as CVV, dCVV, CVV2, dCVV2, and CVC3 values.

An “alias” may be nickname associated with a real identifier. An alias can be a phone number, e-mail address, username, etc. associated with a user's real name (e.g., John Smith). An alias can have any suitable number of type of characters. An alias can be used to conduct transfers instead of sensitive information. This preserves privacy and data security.

A “user” may include an individual or other entity that can use something. Examples of users can include natural persons, and organizations such as ride sharing organizations, insurance claim processing organizations, etc. In some embodiments, a user may be associated with one or more personal accounts and/or mobile devices. The user may also be referred to as a cardholder, account holder, or consumer in some embodiments. A user may be a “receiver” that can receive something. A user can also be a “sender,” which is someone that can send something.

A “receiving entity” can be an entity that receives something, typically on behalf of a receiver. The receiving entity can manage a record (e.g., an account) of a receiver. Examples of receiving entities can include issuers, acquirers, service providers etc. A receiving entity can operate a receiving entity computer.

A “sending entity” can be an entity that sends something, typically on behalf of a sender. The sending entity can manage a record (e.g., an account) of a sender. Examples of sending entities can include issuers, acquirers, service providers etc. A sending entity can operate a sending entity computer.

An “authorizing entity” may be an entity that authorizes a request. Examples of an authorizing entity may be an issuer, a governmental agency, a document repository, an access administrator, etc.

An “issuer” may typically refer to a business entity (e.g., a bank) that maintains an account for a user. An issuer may also issue payment credentials stored on a user device, such as a cellular telephone, smart card, tablet, or laptop to the consumer.

A “server computer” may include a powerful computer or cluster of computers. For example, the server computer can be a large mainframe, a minicomputer cluster, or a group of servers functioning as a unit. In one example, the server computer may be a database server coupled to a Web server. The server computer may be coupled to a database and may include any hardware, software, other logic, or combination of the preceding for servicing the requests from one or more client computers. The server computer may comprise one or more computational apparatuses and may use any of a variety of computing structures, arrangements, and compilations for servicing the requests from one or more client computers.

A “transfer application” can include an application facilitating the transfer of funds between multiple parties. For instance, a transfer application can include a peer-to-peer transaction application. The transfer application can be executed on a mobile device associated with a user, and the transfer application can be implemented using a server (e.g., an application server) in communication with the mobile device. The transfer application can provide an account (e.g., from a digital wallet which may be part of the transfer application or external to it) for each user. The transfer application can allow a user to select a recipient user to transfer a specified amount of funds to the recipient user. The transfer application can then transfer the specified amount from an account for the user to an account for the recipient user.

An “application server” can be a server computer that is specifically designed to run applications. For instance, an application server can perform processing tasks relating to the above-described transfer application, such as provide user account details to be displayed on the transfer application executing on the mobile device or facilitate transfer of funds between users on the transfer application.

A “push transfer message” can include a message that causes value (e.g., funds) to be pushed from one entity to another. In some embodiments, for example, a push transaction message can be generated by the application server to initiate a transaction between a sender and a receiver to push funds to the receiver. In a push transaction, the funds transfer messaging is not first initiated by the intended recipient of the funds. The push transfer message can include user account details, a credential (identified from the receiver alias) relating to the receiver, a transaction amount, and a push transfer indicator (e.g., an OCT indicator). In some instances, the push transfer message can comprise an original credit transaction (OCT) format. Push transactions such as those that use OCT (original credit transaction) messages are processed as single-message transactions, with authorization and clearing performed as a single step. This means that once an authorizing entity computer approves the push transfer message, they can make the funds immediately available to a recipient record, or recipient account, instead of waiting for a separate clearing instruction. Consequently, the push transfer transactions are non-reversable because once value is made available, the recipient can use the value immediately.

A “token” may be a substitute value for a credential. A token may be a string of numbers, letters, or any other suitable characters. Examples of tokens include tokens, access tokens, personal identification tokens, etc. A token may include an identifier for an account that is a substitute for an account identifier, such as a primary account number (PAN). For example, a token may include a series of alphanumeric characters that may be used as a substitute for an original account identifier. For example, a token “4900 0000 0000 0001” may be used in place of a PAN “4147 0900 0000 1234.” In some embodiments, a token may be “format preserving” and may have a numeric format that conforms to the account identifiers used in existing transaction processing networks (e.g., ISO 8583 financial transaction message format). In some embodiments, a token may be used in place of a PAN to initiate, authorize, settle or resolve a transaction or represent the original credential in other systems where the original credential would typically be provided. In some embodiments, a token value may be generated such that the recovery of the original PAN or other account identifier from the token value may not be computationally derived. Further, in some embodiments, the token format may be configured to allow the entity receiving the token to identify it as a token and recognize the entity that issued the token.

“Tokenization” is a process by which data is replaced with substitute data. For example, an account identifier (e.g., a primary account number (PAN)) may be tokenized by replacing the primary account identifier with a substitute number (e.g., a token) that may be associated with the account identifier. Further, tokenization may be applied to any other information that may be replaced with a substitute value. Tokenization may be used to enhance transaction efficiency, improve transaction security, increase service transparency, or to provide a method for third-party enablement.

A “token provider” or “token service system” can include one or more computers that service tokens. In some embodiments, a token service system can facilitate requesting, determining (e.g., generating) and/or issuing tokens, as well as maintaining an established mapping of tokens to primary account numbers (PANs) in a repository (e.g., token vault). In some embodiments, the token service system may establish a token assurance level for a given token to indicate the confidence level of the token to PAN binding. The token service system may include or be in communication with a token vault where the generated tokens are stored. The token service system may support token processing of transactions submitted using tokens by de-tokenizing the token to obtain the actual PAN and conducting a transaction using that PAN. In some embodiments, a token service system may include a tokenization computer alone, or in combination with other computers such as a transaction processing network computer. Various entities of a tokenization ecosystem may assume the roles of the token provider. For example, processing networks and issuers or their agents may become the token provider by implementing the token services according to embodiments of the present invention.

A “transaction” may be any interaction or exchange between two or more parties. For example, a transaction may include a first entity requesting resources from a second entity. In this example, the transaction is completed when the resources are either provided to the first entity or the transaction is declined.

A “transaction processing network,” or “processing network,” may refer to an electronic payment system used to accept, transmit, or process transactions made by payment devices for money, goods, or services. The processing network may transfer information and funds among authorization entities (e.g., issuers), acquirers, merchants, and payment device users.

Embodiments of the invention can improve transaction processing by incorporating push transfer message in partial authorization schemes when value is transferred from a sender to a receiver. Embodiments of the invention can enhance a first push transfer response message with a record value associated with a record from a receiver entity computer to a sender entity computer. This can be done when a value in a first push transfer message exceeds a threshold set by the receiver entity operating the receiver entity computer. In some embodiments, a record is an account such as a credit card account. The record value can be an account balance for the credit card account, and the threshold can be the account balance or an amount less than the account balance for the credit card account. After receiving the first push transfer response message, the sender entity computer can inform the sender that the first push transfer message was declined, and that a second push transfer message can be submitted for the record value in the first push transfer response message. The sender can then initiate the sending of a second push transfer message with the record value or an amount less than the record value from the sender entity computer to the receiver entity computer. Once the second push transfer message is received by the receiver entity computer, the receiver's account can be adjusted with the value in the second push transfer message.

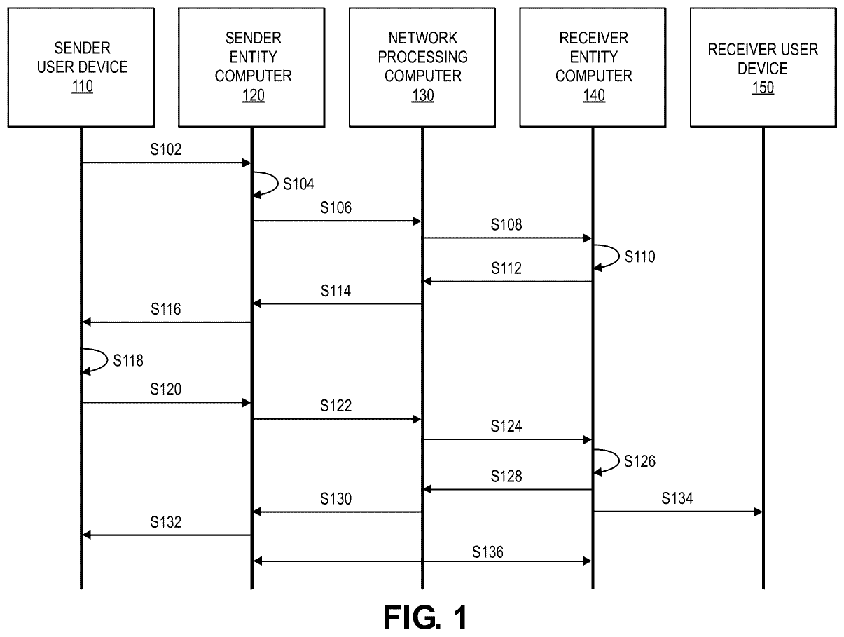

FIG. 1 shows system and a process flow according to an embodiment. The system can include a sender user device 110 in communication with a sender entity computer 120. The sender entity computer 120 is in communication with the receiver entity computer 140 via a network processing computer 130. The receiver entity computer 140 can be in communication with a receiver user device 150.

A sender (not shown) can be an individual user that operates the sender user device 110 and can have a sender record that is managed by the sender entity computer 120. The sender entity computer 120 can be operated by a sender entity such as an issuer (e.g., an issuing bank) or an acquirer (e.g., an acquiring bank). The sender record can be an account such as a debit account, a credit account, or a stored value account.

Although a user that is an individual is discussed as an example, other types of users can include organizations such as ride sharing organizations, insurance claim processing organizations, etc.

A receiver (not shown) can also be an individual user. The receiver can operate the receiver user device 150 and can have a receiver record that is managed by the receiver entity computer 140. The receiver entity computer 140 can be operated by a receiver entity such as an issuer or acquirer. The receiver record can be an account such as a debit account, a credit account or a stored value account.

In some embodiments, the sender user device 110 and the receiver user device 150 can each have transfer applications such as digital wallet applications on them. The transfer applications can be managed by application servers, which may be part of or separate from the sender entity computer 120 and the receiver entity computer 140.

In specific embodiments, the receiver record is a credit account such as a credit card account. The balance of the credit account indicates the amount that the holder of the credit account (e.g., a receiver user) owes an issuer of the account. While the credit account can receive amounts such as refunds, credits, or payments to reduce the balance of the credit account, positive balances in credit accounts are undesirable since credit accounts are designed to allow users to obtain resources using credit. Positive balances in credit accounts can also lead to additional communications between the issuer and the holders of the accounts, which is also undesirable. If credit accounts continually have fluctuating positive balances, then the entities holding those credit accounts may need to continually submit refunds to the receivers, which is not desirable. Positive balances can consume additional resources such as computational resources and result in the transmission of additional messages between computers. In embodiments of the invention, the receiver entity computer may be programmed to decline push transfer messages that have values that are greater than the balances of the credit accounts. The receiver entity computer can be programmed to generate and transmit a push transfer response message with the current balance to inform the sender entity computer and the sender entity of the maximum value that can be pushed to the credit account.

The network processing computer 130 can be in a transaction processing network or system, which may include data processing subsystems, networks, and operations used to support and deliver authorization services, exception file services, transaction scoring services, and clearing and settlement services. An exemplary transaction processing system may include VisaNet™. Transaction processing systems such as VisaNet™ are able to process credit card transactions, debit card transactions, and other types of commercial transactions. VisaNet™, in particular, may include a VIP system (Visa Integrated Payments system) which processes authorization requests and a Base II system which performs clearing and settlement services.

Messages between the devices in FIG. 1 can be transmitted using a secure communications protocols such as, but not limited to, File Transfer Protocol (FTP); HyperText Transfer Protocol (HTTP); Secure Hypertext Transfer Protocol (HTTPS), SSL, ISO (e.g., ISO 8583) and/or the like. The communications network that may include any one and/or the combination of the following: a direct interconnection; the Internet; a Local Area Network (LAN); a Metropolitan Area Network (MAN); an Operating Missions as Nodes on the Internet (OMNI); a secured custom connection; a Wide Area Network (WAN); a wireless network (e.g., employing protocols such as, but not limited to a Wireless Application Protocol (WAP), I-mode, and/or the like); and/or the like. The communications network can use any suitable communications protocol to generate one or more secure communication channels. A communications channel may, in some instances, comprise a secure communication channel, which may be established in any known manner, such as through the use of mutual authentication and a session key, and establishment of a Secure Socket Layer (SSL) session.

Methods according to embodiments of the invention can be described with respect to FIG. 1.

In step S102, a sender operating a sender user device 110 can communicate with the sender entity computer 120 to initiate a push transfer transaction. The sender user device 110 can transmit an origination message comprising instructions to push a value to a receiver record (e.g., a receiver account) managed by the receiver entity computer 140. The origination message may comprise the value, and information associated with the receiver record such as a receiver alias, a token (e.g., a payment token), or a receiver credential (e.g., a receiver PAN or primary account number such as a receiver credit card number).

In step S104, the sender entity computer 120 can generate a first push transfer message using at least the information in the origination message. The first push transfer message can be an OCT message, and can include the value, a push transfer indicator (e.g., an OCT indicator), and the receiver credential, a receiver alias, or a token. In some embodiments, the sender entity computer 120 and the network processing computer 130 can communicate via an API (application programming interface).

In step S106, the sender entity computer 120 can transmit the first push transfer message to the network processing computer 130.

If the first push transfer message comprises an alias or a token, then the network processing computer 130 can determine the credential of the receiver using the alias or the token. For example, the network processing computer 130 can look up the credential in a database using the alias or the token. Once the credential is obtained, the network processing computer 130 can analyze the credential, and determine an address of the receiver entity computer 140 using a portion of the credential. For example, if the credential of the receiver is a credit card number that is sixteen digits long, then the first six digits may identify the receiver entity associated with the receiver entity computer 140, and also the receiver entity computer 140.

In step S108, the network processing computer 130 can modify the first push transfer message to include the credential. The network processing computer 130 can then transmit the first push transfer message comprising the credential and the value to the receiver entity computer 140.

At step S110, the receiver entity computer 140 can analyze the first push transfer message. It can determine if the value in the first push transfer message exceeds a threshold. In some embodiments, the threshold can be a static or fluctuating value. In some embodiments, the threshold can be equal to a record value of the receiver record maintained by the receiver entity computer 140. If the value in the first push transfer message is equal to or smaller than the threshold (e.g., larger than a credit card balance of the receiver), then the receiver entity computer 140 can immediately adjust the record value of the receiver. The receiver entity computer can also respond with approval. For example, the receiver entity computer 140 can credit the record of the receiver with an amount equal to the value in the first push transfer message. If the value in the first push transfer message is larger than the threshold (e.g., larger than a credit card balance of the receiver), then the issuer computer 40 can generate a first push transfer response message declining the transaction. The first push transfer response message can include a value that is equal to or less than the record value of the receiver record, and an indicator declining the first push transfer message. For example, if the receiver's credit card account has a $1000 balance, then any OCT transaction to credit the credit card account would be equal to or less than $1000. If, for instance, the OCT request message had a transaction amount of $2000, then the issuer operating the issuer computer 40 could end up owing the beneficiary money on the credit card account, which is not desirable since credit accounts are not designed to continuously maintain balances in which the receiver entity owes its affiliated receivers. Although the threshold is derived using the record value of the receiver's record, it need not be. For instance, the receiver entity computer 140 can set the threshold to a value that it is willing to process on a period basis.

At step S112, the receiver entity computer 140 can transmit the first push transfer response message to the network processing computer 130.

At step S114, the network processing computer 130 can transmit the first push response message to the sender entity computer 120.

At step S116, the sender entity computer 120 can notify the user of the sender user device 110 that the push transaction was declined and that a new push transaction can be initiated with the value in the first push transfer response message.

In step S118, the sender operating the sender user device 110 may cause the sender user device 110 to reply to the sender entity computer 120, thereby initiating a second push transaction using the value in the first push transfer response message.

In step S120, a revised initiation message can be transmitted from the sender user device 110 to the sender entity computer 120. The sender entity computer 120 can then receive the revised initiation message. The revised initiation message can have a record value that is less than or equal to the value in the first push transaction message.

In step S122, the sender entity computer 120 can generate and transmit to the network processing computer 130 a second push transfer message. The second push transfer message may comprise the alias of the receiver, the token, or the credential of the receiver. The second push transfer message may also comprise the record value or another value less than the record value, and a push transfer message indicator. The second push transfer message can include a value that is the same as in the revised initiation message in step S120.

In step S124, if the second push transfer message included the alias or the token, the network processing computer 130 can modify the second push transfer message to include the credential. The network processing computer 130 can then transmit the second push transfer message comprising the credential and the value to the receiver entity computer 140.

In step S126, the receiver entity computer 140 can determine that the value in the second push transfer message is less than or equal to the current threshold value.

In step S134, the receiver entity computer 140 can immediately adjust (e.g., credit) the receiver account for the value in the second push transfer message, and can transmit a message to the receiver user device 150 informing the receiver.

In step S128, a second push transfer response message comprising an approval indicator and the credential is transmitted from the receiver entity computer 140 to the network processing computer 130.

In step S130, the second push transfer response message may be transmitted from the network processing computer 130 to the sender entity computer 120.

In step S132, the sender entity computer 120 notifies the sender via the sender user device 110 that the second push transaction was successful.

In step S136, at a later time, actual funds are transferred from the sender record managed by the sender entity computer 120 to the receiver entity computer 140.

Other embodiments can automate the initiation of subsequent push transfer messages, without a specific action on the sender. For example, in some embodiments, after the sender entity computer 120 receive the first push transfer response message with the record value of the receiver, the sender entity computer 120 could automatically transmit a second push transfer message to the network processing computer as in step S122 without requesting approval from the sender operating the sender user device 110. In this case, some of the originally requested value may not have been credited to the receiver record managed by the receiver entity computer 140. For example, if the receiver record had a credit balance or threshold value of $100 and the first push transaction message included a value of $200, then the second push transfer message could have included a value of $100 to meet the current threshold value. The sender entity computer 120 can indicate in the sender record that $100 is still owed to the receiver. The receiver's record value may increase over time as the receiver incurs more debt and the receiver's record value may reach a value of $100, and this may be a new threshold associated with the receiver record. The receiver entity computer 140 can then automatically transmit the value of the receiver record in a supplemental message to the sender entity computer 120, and the sender entity computer 120 can transmit a subsequent push transfer message with the value of $100 to the receiver entity computer 140, and the receiver entity computer 140 can then credit the receiver record for the amount of the subsequent push transfer message, thereby ensuring that the receiver obtained all of the value that it was supposed to receive from the sender.

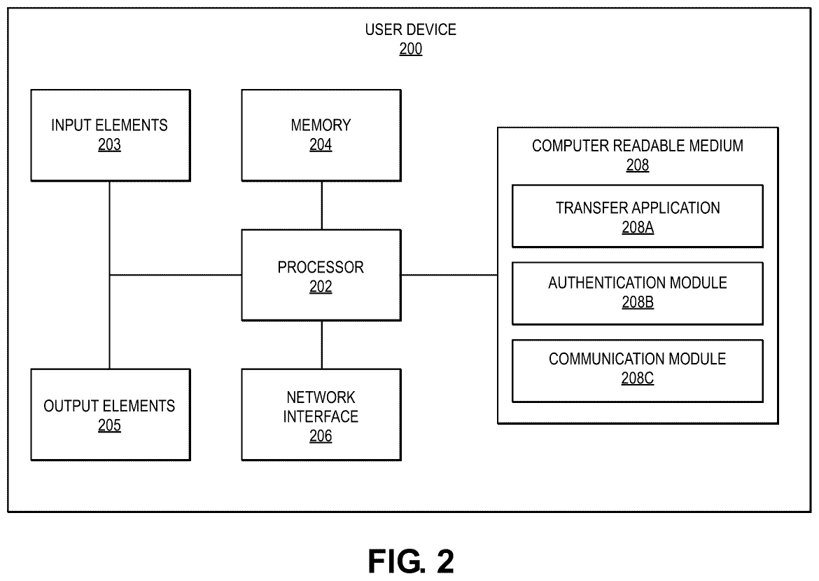

FIG. 2 shows a block diagram of a user device 200 according to embodiments. The user device 200 may comprise a processor 202. The processor 202 may be coupled to an input element 203, an output element 205, a memory 204, a network interface 206, and a computer readable medium 208. The computer readable medium 208 may comprise any suitable number and types of software modules.

Examples of input elements may include microphones, keypads, touchscreens, sensors, etc. Examples of output elements may include speakers, display screens, and tactile devices. The processor 202 can be implemented as one or more integrated circuits (e.g., one or more single core or multicore microprocessors and/or microcontrollers) and can be used to control the operation of the user device 200. The processor 202 can execute a variety of programs in response to program code or computer-readable code and can maintain multiple concurrently executing programs or processes.

The memory 204 may be used to store data and code. The memory 204 may be coupled to the processor 202 internally or externally (e.g., via cloud-based data storage), and may comprise any combination of volatile and/or non-volatile memory such as RAM, DRAM, ROM, flash, or any other suitable memory device. In some embodiments, the memory 204 may store the data items of a payload.

The network interface 206 may include an interface that can allow the user device 200 to communicate with external computers. The network interface 206 may enable the user device 200 to communicate data to and from another device such as an aggregation entity computer, a server computer, a transport computer, an authorizing entity computer, etc. Some examples of the network interface 206 may include a modem, a physical network interface (such as an Ethernet card or other Network Interface Card (NIC)), a virtual network interface, a communications port, a Personal Computer Memory Card International Association (PCMCIA) slot and card, or the like. The wireless protocols enabled by the network interface 206 may include Wi-Fi™. Data transferred via the network interface 206 may be in the form of signals which may be electrical, electromagnetic, optical, or any other signal capable of being received by the external communications interface (collectively referred to as “electronic signals” or “electronic messages”). These electronic messages that may comprise data or instructions may be provided between the network interface 206 and other devices via a communications path or channel. As noted above, any suitable communication path or channel may be used such as, for instance, a wire or cable, fiber optics, a telephone line, a cellular link, a radio frequency (RF) link, a WAN or LAN network, the Internet, or any other suitable medium.

The computer readable medium 208 may comprise several software modules including, but not limited to, a transfer application 208A, an authentication module 208B, and a communication module 208C.

The transfer application 208A may enable communication with a transfer application server. The transfer application 208A may include instructions or code implementing a transfer application 208A for initiating a transfer of funds to a receiver account of a receiver.

The authentication module 208B can comprise code that causes the processor 202 to perform authentication processes including password verification, biometric verification, etc.

The communication module 208C may comprise code that causes the processor 202 to generate messages, forward messages, receive message, reformat messages, and/or otherwise communicate with other entities.

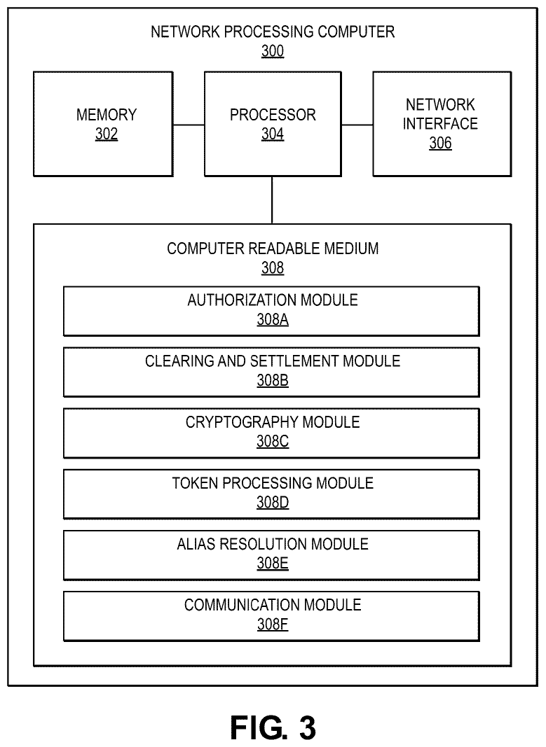

FIG. 3 shows a block diagram of a network processing computer 300 according to embodiments. The exemplary network processing computer 300 may comprise a processor 304. The processor 304 may be coupled to a memory 302, a network interface 306 and a computer readable medium 308. The computer readable medium 308 can comprise an authorization module 308A, a clearing and settlement module 308B, a cryptography module 308C, a token processing module 308D, an alias resolution module 308E, and a communication module 308F.

The memory 302 can be used to store data and code. The memory 302 may be coupled to the processor 304 internally or externally (e.g., cloud based data storage), and may comprise any combination of volatile and/or non-volatile memory, such as RAM, DRAM, ROM, flash, or any other suitable memory device. For example, the memory 302 can store interaction data, tokens, aliases, credentials, etc.

The computer readable medium 308 may comprise code, executable by the processor 304, for performing a method comprising: receiving, from a sender entity computer, a first push transfer message comprising a value; transmitting, by the network processing computer, the first push transfer message to a receiver entity computer, wherein the receiver entity computer determines that the value exceeds a threshold, and transmits, to the network processing computer, a first response message comprising a record value associated with a record maintained by the receiver entity computer, and an indicator declining the first push transfer message; receiving, by the network processing computer, the first response message; transmitting, by the network processing computer, the first response message to the sender entity computer; receiving, by the network processing computer, a second push transfer message comprising the record value or another value less than the record value; receiving, by the network processing computer, a second response message comprising an approval indicator; and transmitting, by the network processing computer, the second response message comprising the approval indicator to the sender entity computer.

The authorization module 308A can include code, executable by the processor 304 for modifying, routing, and otherwise processing authorization request and response messages, push transfer request and response messages, etc.

The clearing and settlement module 308B can include code, executable by the processor 304, for performing clearing and/or settlement processes.

The token processing module 308D can include code, executable by the processor 304, for performing token processing functions including creating or obtaining tokens, verifying tokens, and performing detokenization and retokenization processes. The token processing module 308D can perform the functions described above with respect to the token provider or token service system.

The alias resolution module 308E can include code, executable by the processor 304 for obtaining credential associated with aliases, and obtaining aliases associated with credentials.

The cryptography module 308C may comprise code or software, executable by the processor 304, for performing cryptographic operations including creating and verifying cryptograms. The cryptography module 308C, in conjunction with the processor 304, can encrypt (or decrypt) data elements using an encryption process such as DES, triple DES, or AES using any suitable encryption keys. The encryption keys may also be UDKs or unique derived keys, and may be generated based upon device specific information such as an account number, which may be encrypted using a master derivation key (MDK).

The communication module 308F may comprise code or software, executable by the processor 304, for communicating with other devices. The communication module 308F may be configured or programmed to perform some or all of the functionality associated with receiving, sending, and generating electronic messages for transmission.

The network interface 306 may include an interface that can be similar to or different than the network interface 206 in FIG. 2, and the descriptions thereof are incorporated herein.

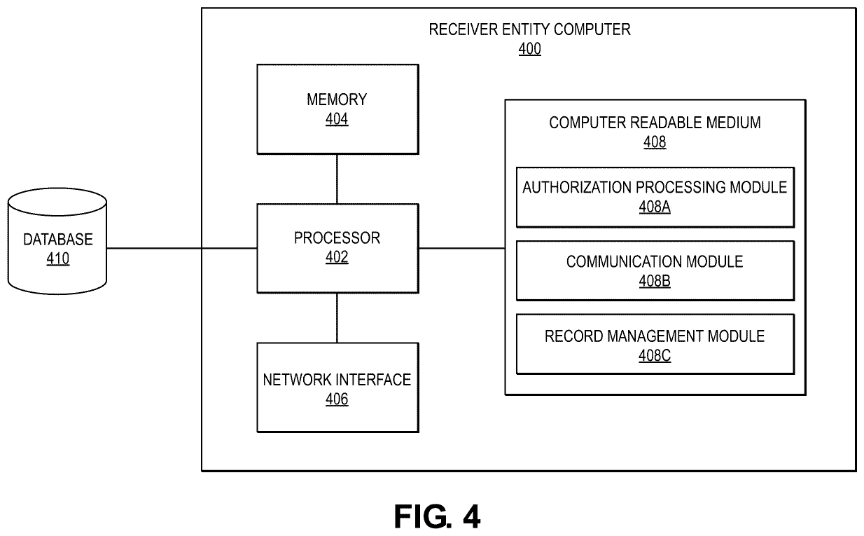

FIG. 4 shows a block diagram of a receiver entity computer 400 according to embodiments. The receiver entity computer 400 may comprise a processor 402. The processor 402 may be coupled to a memory 404, a network interface 406, a computer readable medium 408, and a database 410.

The memory 404 can be used to store data and code. In some embodiments, the memory 404 may be linked to a database 410. The memory 404 and/or the database 410 may be coupled to the processor 402 internally or externally (e.g., via cloud-based data storage), and may comprise any combination of volatile and/or non-volatile memory such as RAM, DRAM, ROM, flash, or any other suitable memory device.

The network interface 406 may have similar or different feature as the network interface 206 and 306 in FIGS. 2 and 3, and the descriptions thereof are incorporated herein.

The computer readable medium 408 may comprise code, executable by the processor 402, for a method comprising: receiving, from a network processing computer, a first push transfer message comprising a credential and a value, determining that the value exceeds a threshold, transmitting, to the network processing computer, a first response message comprising a record value associated with a record maintained by the receiver entity computer, and an indicator declining the first push transfer message, receiving, from the network processing computer, a second push transfer message comprising the record value or another value less than the record value, and transmitting, to the network processing computer, a second response message comprising an approval indicator.

The computer readable medium 408 may comprise several software modules including, but not limited to, an authorization processing module 408A, a communication module 408B, and a record management module 408C.

The authorization processing module 408A can include code, executable by the processor 402 to perform authorization processing. This may include determining if a value in a push transfer message exceeds a threshold.

The communication module 408B may comprise code that causes the processor 402 to generate messages, forward messages, receive message, reformat messages, and/or otherwise communicate with other entities.

The record management module 408C may comprise code that causes the processor 402 to manage records of receivers. The records may be accounts such as debit or credit accounts.

Embodiments of the invention have a number of technical advantages. Embodiments of the invention allow a sender to send a value to a receiver with a minimal number of messages and steps, while ensuring that the sending of the value complies with any set value thresholds set by a receiving entity. In the case where the record is a credit account managed by the receiving entity, limiting the amounts of push transaction amounts to the credit account can prevent the receiving entity from repeatedly sending the receiver any values to the receiver for positive balances in the credit account. This saves upon computing resources and data processing steps, relative to conventional systems.

Any of the software components or functions described in this application, may be implemented as software code to be executed by a processor using any suitable computer language such as, for example, Java, C++ or Perl using, for example, conventional or object-oriented techniques. The software code may be stored as a series of instructions, or commands on a computer readable medium, such as a random access memory (RAM), a read only memory (ROM), a magnetic medium such as a hard-drive or a floppy disk, or an optical medium such as a CD-ROM. Any such computer readable medium may reside on or within a single computational apparatus, and may be present on or within different computational apparatuses within a system or network.

The above description is illustrative and is not restrictive. Many variations of the invention may become apparent to those skilled in the art upon review of the disclosure. The scope of the invention can, therefore, be determined not with reference to the above description, but instead can be determined with reference to the pending claims along with their full scope or equivalents.

One or more features from any embodiment may be combined with one or more features of any other embodiment without departing from the scope of the invention.

A recitation of “a”, “an” or “the” is intended to mean “one or more” unless specifically indicated to the contrary.

All patents, patent applications, publications, and descriptions mentioned above are herein incorporated by reference in their entirety for all purposes. None is admitted to be prior art.

What is claimed is:

1. A method comprising:
receiving, by a receiver entity computer from a network processing computer, a first push transfer message comprising a credential and a value;
determining, by the receiver entity computer, that the value exceeds a threshold;
transmitting, by the receiver entity computer to the network processing computer, a first response message comprising a record value associated with a record maintained by the receiver entity computer, and an indicator declining the first push transfer message;
receiving, by the receiver entity computer from the network processing computer, a second push transfer message comprising the record value or another value less than the record value; and
transmitting, by the receiver entity computer to the network processing computer, a second response message comprising an approval indicator.

2. The method of claim 1, wherein before the receiver entity computer receives the first push transfer message from the network processing computer, the network processing computer receives the first push transfer message from a sender entity computer, which receives an origination message from a sender user device associated with a sender.

3. The method of claim 2, wherein the record is associated with a receiver.

4. The method of claim 3, wherein the network processing computer is programmed to analyze the credential, determine an address of the receiver entity computer using a portion of the credential, and transmit the first push transfer message to the receiver entity computer.

5. The method of claim 4, wherein the network processing computer and the sender entity computer communicate via an API (application programming interface).

6. The method of claim 4, wherein the network processing computer receives the first push transfer message comprising a token or an alias from the sender entity computer, and wherein the network processing computer resolves the token or the alias into the credential, and replaces the token or alias with the credential in the first push transfer message.

7. The method of claim 3, wherein the first push transfer message is a first OCT message.

8. The method of claim 7, wherein the second push transfer message is a second OCT message.

9. The method of claim 7, wherein the record is a credit account.

10. The method of claim 1, wherein the threshold is the record value.

11. The method of claim 1, further comprising:
transmitting, by the receiver entity computer, a message to a receiver user device indicating that the record has been modified with an amount equal to the record value or the another value less than the record value.

12. A receiver entity computer comprising:
a processor; and
a non-transitory computer readable medium comprising code executable by the processor, for performing operations comprising
receiving, from a network processing computer, a first push transfer message comprising a credential and a value,
determining that the value exceeds a threshold,
transmitting, to the network processing computer, a first response message comprising a record value associated with a record maintained by the receiver entity computer, and an indicator declining the first push transfer message,
receiving, from the network processing computer, a second push transfer message comprising the record value or another value less than the record value, and
transmitting, to the network processing computer, a second response message comprising an approval indicator.

13. The receiver entity computer of claim 12, wherein the record is associated with a receiver.

14. The receiver entity computer of claim 12, wherein the threshold is a value other than the record value, and the second push transfer message comprises the credential.

15. A method comprising:
receiving, by a network processing computer from a sender entity computer, a first push transfer message comprising a value;
transmitting, by the network processing computer, the first push transfer message to a receiver entity computer, wherein the receiver entity computer determines that the value exceeds a threshold, and transmits, to the network processing computer, a first response message comprising a record value associated with a record maintained by the receiver entity computer, and an indicator declining the first push transfer message;
receiving, by the network processing computer, the first response message;
transmitting, by the network processing computer, the first response message to the sender entity computer;
receiving, by the network processing computer, a second push transfer message comprising the record value or another value less than the record value;
receiving, by the network processing computer, a second response message comprising an approval indicator; and
transmitting, by the network processing computer, the second response message comprising the approval indicator to the sender entity computer.

16. The method of claim 15, wherein the first push transfer message comprises an alias or a token.

17. The method of claim 16, further comprising:
resolving the alias or the token to a credential, and inserting the credential for the alias or token before transmitting the first push transfer message to the receiver entity computer.

18. The method of claim 15, wherein the second push transfer message further comprises a credential.

19. The method of claim 15, wherein the first push transfer message and the second push transfer message are OCT messages.

20. The method of claim 15, wherein the first push transfer message comprises a credential, and the method further comprises:
analyzing, by the network processing computer, the credential to determine an address of the receiver entity computer using a portion of the credential and using the address to transmit the first push transfer message to the receiver entity computer.
